(19) United States
(12) Patent Application Publication
(10) Pub. No.: US 2011/0132130 A1
(43) Pub. Date: Jun. 9, 2011

(54) MANIPULATOR AND ASSEMBLY METHOD THEREOF

(75) Inventor: ZHEN-XING LIU, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/716,639

(22) Filed: Mar. 3, 2010

(30) Foreign Application Priority Data
Dec. 3, 2009 (CN) 200910310834.1

(51) Int. Cl. B25J 18/00; B23P 11/00; B25J 17/00

(52) U.S. Cl. 74/490.05; 29/428; 901/27; 901/28

(57) ABSTRACT

A manipulator includes a first arm, a second arm, a joint assembly, and many connecting members. The first arm defines a first axle hole. The second arm defines a second axle hole and two openings adjacent to the second axle hole. The joint assembly is received in the first arm and rotatably joins the first arm and the second arm. Each of the connecting members includes a head portion and a fixing portion. The head portion is received in the first arm. The fixing portion connects the second arm and the joint assembly.

### BACKGROUND

1. Technical Field

The present disclosure generally relates to manufacturing technology, and particularly, to a manipulator and assembly method thereof.

2. Description of Related Art

As developments in manufacturing technology grows, manipulators are increasingly applied to perform functions in environments considered hazardous or difficult for operators. Manipulator arms are standard elements of the manipulator.

A frequently used manipulator includes a first arm having a cavity and a second arm joined to the first arm with a coupling. One end of the coupling is connected to one end of the second arm, and the other end of the coupling is received in the first arm. During insertion of the coupling into the first arm, bearings, gland bushes, and felt washers are sleeved at both ends of the coupling, after which an electrical motor, retarder, and other elements are assembled into the first arm from the other end of the first arm, such that the end of the coupling away from the second arm is connected with the retarder in the first arm.

Because the coupling has been received in the first arm, only the second arm can be held to accomplish assembly of the motor, retarder, and other elements. Further, since the central axes of the bearings, gland bushes, and felt washers must remain coaxial to assemble the coupling to the first arm, the assembly is considerably complicated.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an assembled, isometric view of an embodiment of a manipulator.

FIG. 2 is a cross-section of the manipulator of FIG. 1, taken along line II-II.

FIG. 3 is an exploded, isometric view of the manipulator of FIG. 1.

FIG. 4 is a flowchart of a method of assembling the manipulator of FIG. 1.

### DETAILED DESCRIPTION

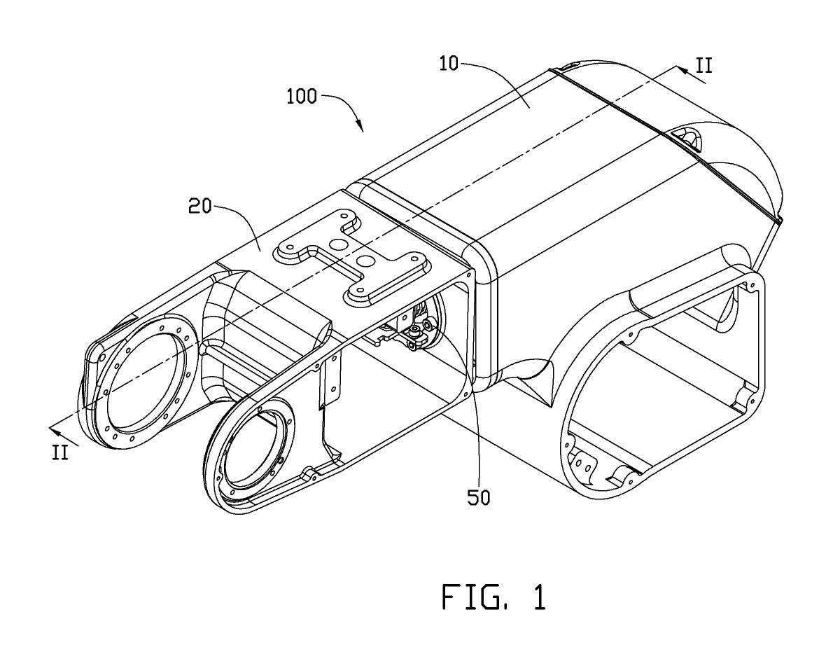

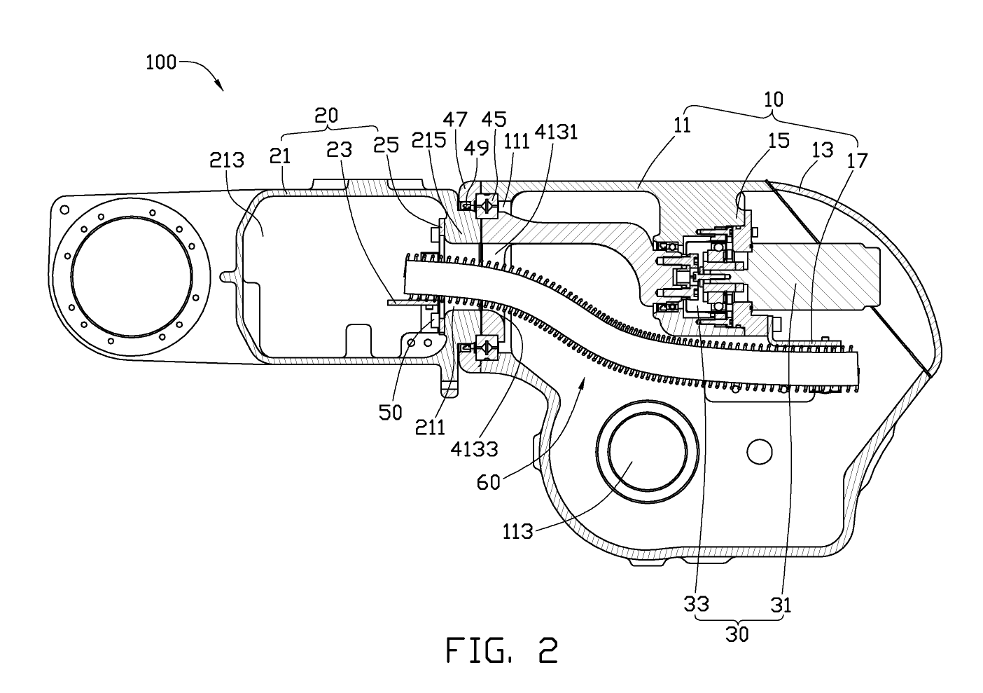

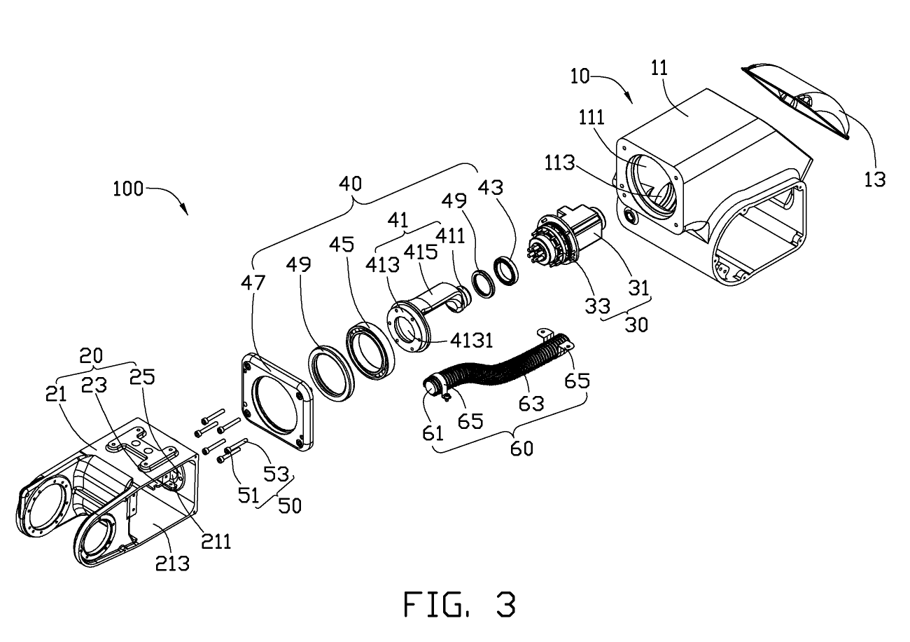

Referring to FIGS. 1 and 2, a manipulator 100 includes a first arm 10, a second arm 20, a driving assembly 30, a joint assembly 40 (shown in FIG. 3), a plurality of connecting members 50, and a cable assembly 60.

The first arm 10 and the second arm 20 are rotatably joined by the joint assembly 40. The driving assembly 30 is received in the first arm 10, and the joint assembly 40 is partially received in the first arm 10. The connecting members 50 are received in the second arm 20, and the cable assembly 60 passes through the first arm 10 and the second arm 20.

Referring to FIGS. 2 and 3, the first arm 10 includes a first main body 11, a cover 13 fixed on the first main body 11, and a first retaining seat 15 and a second retaining seat 17 both received in the first arm 10. The first main body 11 defines a first axle hole 111 in an end away from the other end fixed with the cover 13. The first retaining seat 15 and the second retaining seat 17 protrude from an inner side of the first main body 11. The first retaining seat 15 fixes the driving assembly 30, and the second retaining seat 17 fixes the cable assembly 60. In the illustrated embodiment, the first main body 11 is formed by casting, and the first main body 11 defines an engaging axle hole 113 having an axis substantially perpendicular to that of the first axle hole 111. The first retaining seat 15 is formed together with the first main body 11 by casting, and the second retaining seat 17 is fixed on the first retaining seat 15. The first retaining seat 15 may be connected to the first main body 11 by other means such as welding, adhering, and fastening.

The second arm 20 includes a second main body 21, a third retaining seat 23, and a cushion ring 25. The second main body 21 defines a second axle hole 211 and two openings 213 adjacent to the second axle hole 211. The second main body 21 further forms a protrusion 215 on one end of the second main body 21, and the second axle hole 211 is defined in the protrusion 215 and communicates with the inside of the second main body 21. The second axle hole 211 is defined corresponding to the first axle hole 111 of the first main body 11 of the first arm 10. The openings 213 are defined at two opposite sides of the second main body 21. The second arm 20 is capable of being closed by two covers (not shown) to cover the openings 213. The third retaining seat 23 is disposed adjacent to the second axle hole 211 of the second main body 21. The cushion ring 25 is disposed to surround the second axle hole 211. In other embodiments, the number of openings 213 may be one or more than two.

The driving assembly 30 includes an actuator 31 and a retarder 33 driven by the actuator 31. The retarder 33 transfers the power of the actuator 31 to the joint assembly 40. In the illustrated embodiment, the actuator 31 is a motor and may be replaced by pneumatic cylinder, hydraulic cylinder, or other actuating device. The retarder 33 can be a harmonic retarder.

The joint assembly 40 includes a coupling 41, a first bearing 43 disposed on one end of the coupling 41, a second bearing 45 and an end cover 47 disposed on the other end of the coupling 41, and two sealing rings 49 disposed on opposite ends of the coupling 41. Each end of the coupling 41 is sleeved by one sealing ring 49.

The coupling 41 includes a first connecting portion 411 and a second connecting portion 413 on two opposite ends, and a transition portion 415 therebetween. The second connecting portion 413 defines a through hole 4131, and a side of the second connecting portion 413 forms a smooth chamfer 4133 surrounding the through hole 4131. The transition portion 415 connects corresponding edges of the first connecting portion 411 and the second connecting portion 413, such that a space is formed between the first connecting portion 411 and the second connecting portion 413 through which the cable assembly 60 passes.

In the illustrated embodiment, the first bearing 43 is a ball bearing, and the second bearing 45 is a thrust roller bearing. The first bearing 43 and the second bearing 45 may alternatively be other bearings capable of enduring both axial force and radial force, such as angular contact bearings, needle bearings, integrated bearings with needle bearings and thrust ball bearings, integrated bearings with needle bearing and angular contact ball bearing, and so on.

Each of the connecting members 50 includes a head portion 51 and a fixing portion 53. In the illustrated embodiment, there are six connecting members 50 and the connecting members 50 are screws. Alternatively, the number of connecting members 50 may be one or more.

The cable assembly 60 includes a cable 61, a protecting sleeve 63, and two latching members 65. The protecting sleeve 63 is sleeved on the cable 61, and two latching members 65 fix two ends of the cable 61 to the first arm 10 and the second arm 20 respectively. In the illustrated embodiment, the protecting sleeve 63 is a spring tube, and the protecting sleeve 63 may be replaced by a plastic tube or a rubber tube.

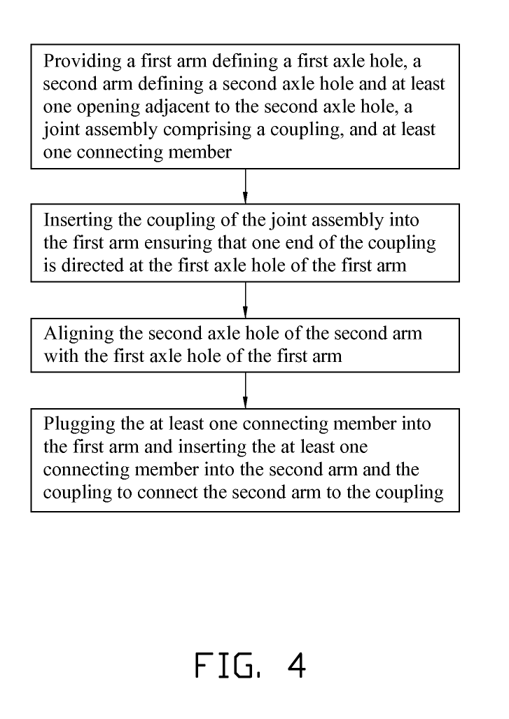

Also referring to FIG. 4, a method of assembling the manipulator 100 depicted above, includes: providing a first arm 10 defining a first axle hole 111, a second arm 20 defining a second axle hole 211 and at least one opening 213 adjacent to the second axle hole 211, a joint assembly 40 comprising a coupling 41, and at least one connecting member 50; inserting the coupling 41 of the joint assembly 40 into the first arm 10 ensuring that one end of the coupling 41 aims at the first axle hole 111 of the first arm 10; aligning the second axle hole 211 of the second arm 20 with the first axle hole 111 of the first arm 10; and plugging the at least one connecting member 50 into the first arm 10 and inserting the at least one connecting member 50 into the second arm 20 and the coupling 41 to connect the second arm 20 to the coupling 41.

During the process of assembly of the manipulator 100, the retarder 33 of the driving assembly 30 is assembled to the first retaining seat 15 of the first main body 11 of the first arm 10, and the actuator 31 is assembled to an end of the retarder 33 away from a portion defining the first axle hole 111.

The first bearing 43 and one of the sealing rings 49 of the joint assembly 40 are inlaid to the first retaining seat 15 and are adjacent to an end of the retarder 33 of the driving assembly 30 away from the actuator 31. The first connecting portion 411 of the coupling 41 is received in the first bearing 43 and one of the sealing rings 49 in the first retaining seat 15, and fixed to the retarder 33 of the driving assembly 30, such that the transition portion 415 is received in the first main body 11 of the first arm 10, and the second connecting portion 413 of the coupling 41 is received in the first axle hole 111 of the first main body 11. The second bearing 45 of the joint assembly 40 is received in the first axle hole 111 and sleeved on the second connecting portion 413 of the coupling 41. The end cover 47 of the joint assembly 40 is fixed to the end of the first main body 11 to prevent the coupling 41 from disengaging from the first main body 11 of the first arm 10. The other sealing ring 49 is received in the end cover 47.

The protrusion 215 of the second main body 21 of the second arm 20 is received in the sealing member 49, the end cover 47, and the second bearing 45 sequentially, such that the second axle hole 211 of the second main body 21, the through hole 4131 of the coupling 41, and the first axle hole 111 of first main body 11 are substantially coaxial. Furthermore, the end of the second main body 21 which defines the second axle hole 211, resists the second connecting portion 413 of the coupling 41.

The connecting members 50 are plugged into the second main body 21 of the second arm 20 through the openings 213, and received in the cushion ring 25, the protrusion 215 of the second main body 21, and the second connecting portion 413 around the second axle hole 211 of the second main body 21. The head portions 51 of the connecting members 50 are received in the second main body 21 and the fixing portions 53 connect the second main body 21 to the coupling 41.

The cable 61 and the protecting sleeve 63 are received in the first arm 10 through the engaging axle hole 113 of the first main body 11, or through a portion where the cover 13 is fixed. Furthermore, the cable 61 and the protecting sleeve 63 run through the first axle hole 111 of the first main body 11 of the first arm 10, the through hole 4131 of the coupling 41, and the second axle hole 211 of the second main body 21 of the second arm 20, thereby, the cable 61 and the protecting sleeve 63 extend into the second arm 20. The cable 61 and the protecting sleeve 63 are fixed to the second retaining seat 17 in the first main body 11 by one of the latching members 65, and fixed to the third retaining seat 23 in the second main body 21 by the other one of the latching members 65.

The cover 13 of the first arm 10 is fixed to the first main body 11, and the manipulator 100 is assembled.

In the manipulator 100, the second arm 20 is assembled to the joint assembly 40 after the joint assembly 40 is assembled to the first arm 10, and the elements of the joint assembly 40 such as the first bearing 43, one of the sealing rings 49, the coupling 41, the second bearing 45, the end cover 47, and the other one of the sealing rings 49 are inserted and assembled to the first arm 10 one by one. Since the elements are assembled individually, assembly is much easier. In addition, the first connecting portion 411 of the coupling 41 is easily directed at the first retaining seat 15, and the first bearing 43 and one of the sealing rings 49 therein when the coupling 41 is assembled to the first arm 10 individually. Moreover, when the second arm 20 requires repair or replacement, only the second arm 20 needs to be disassembled, which is easily disassembled and reassembled, thus less time is spent.

Because the second main body 21 of the second arm 20 receives few elements and two openings 213 are adjacent to the second axle hole 211 of the second main body 21, the connecting members 50 are conveniently received in the second arm 20 through the openings 213, and sufficient space for a tool (not shown) to fasten the connecting members 50 is provided.

In the manipulator 100, the connecting members 50 are received in the second main body 21 and the coupling 41 from inside of the second main body 21, and the head portions 51 of the connecting members 50 are received in the second main body 21. Thereby, one side of the second connecting portion 413 of the coupling 41 facing the first connecting portion 411 does not require a planar surface for inserting the connecting members 50 therefrom. Furthermore, the smooth chamfer 4133 is allowed to be formed at this side of the second connecting portion 413 of the coupling 41 to protect the cable 61 and the protecting sleeve 63 from being abraded. In addition, the third retaining portion 23 of the second arm 20 is disposed adjacent to the second axle hole 211 of the second main body 21, such that the cable 61 and the protecting sleeve 63 are fixed adjacent to second axle hole 211 by the latching member 65 to prevent being abraded by the connecting members 50.

The protecting sleeve 63 of the cable assembly 60 protects the cable 61 from being abraded.

Since the cushion ring 25 is disposed in the second main body 21 of the second arm 20 and around the second axle hole 211 to ensure that the connecting members 50 are fixed steadily, a circular plane around the second axle hole 211 on the second main body 21 is not needed.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A manipulator, comprising:
a first arm defining a first axle hole;
a second arm defining a second axle hole and at least one opening adjacent to the second axle hole, wherein the second axle hole corresponds to the first axle hole;
a joint assembly received in the first arm and rotatably joining the second arm to the first arm; and
at least one connecting member comprising a head portion and a fixing portion, wherein the head portion is received in the second arm, and the fixing portion connects the second arm and the joint assembly.

2. The manipulator of claim 1, wherein the joint assembly comprises a coupling which comprises a first connecting portion, a second connecting portion, and a transition portion between and connecting the first connecting portion and the second connecting portion; the first connecting portion of the coupling connects the first arm and the second connecting portion connects the second arm.

3. The manipulator of claim 2, wherein the second connecting portion defines a through hole; a side of the second connecting portion facing the first connecting portion defines a smooth chamfer around the through hole.

4. The manipulator of claim 3, wherein the transition portion of the coupling connects corresponding edges of the first connecting portion and the second connecting portion.

5. The manipulator of claim 2 further comprising a cable assembly running through the first arm and the second arm.

6. The manipulator of claim 2 further comprising a driving assembly received in the first arm and connecting with the first connecting portion of the coupling, wherein the driving assembly comprises a driver and a retarder, the driver is capable of driving the coupling to rotate through the retarder.

7. The manipulator of claim 6, wherein the first arm comprises a first main body and a first retaining seat in the first main body; the retarder of the driving assembly is fixed on the first retaining seat.

8. The manipulator of claim 1, wherein a second arm comprises a second main body and a cushion ring in the second main body; the cushion ring is disposed around the second axle hole; the at least one connecting member is inserted through the cushion ring.

9. An assembly method of a manipulator, comprising:
providing a first arm defining a first axle hole, a second arm defining a second axle hole and at least one opening adjacent to the second axle hole, a joint assembly comprising a coupling, and at least one connecting member;
inserting the coupling of the joint assembly into the first arm ensuring that one end of the coupling is directed at the first axle hole of the first arm;
aligning the second axle hole of the second arm with the first axle hole of the first arm; and
plugging the at least one connecting member into the first arm and inserting the at least one connecting member into the second arm and the coupling to connect the second arm to the coupling.

10. The assembly method of a manipulator of claim 9, wherein the first arm comprises a first main body and a first retaining seat in the first main body, and the manipulator further comprises a driving assembly assembled to the first retaining seat before the coupling of the joint assembly is received in the first arm.

11. The assembly method of a manipulator of claim 10, wherein the joint assembly further comprises a first bearing, a second bearing, and an end cover, the first bearing being assembled in the first retaining seat before the coupling is received in the first arm, the second bearing being received in the first axle hole of the first arm, and the end cover being fixed to one end of the first arm defining the first axle hole.

12. The assembly method of a manipulator of claim 10, further providing a cable assembly comprising a cable received in the first arm and the second arm after the second arm is connected to the joint assembly.

13. The assembly method of a manipulator of claim 11, wherein the cable assembly further comprises two latching members; the first arm further comprises a second retaining seat in the first main body; the second arm comprises a second main body and a third retaining seat in the second main body; the cable is fixed to the second retaining seat and the third retaining seat by the latching members.

14. The assembly method of a manipulator of claim 12, wherein the cable assembly further comprises a protecting sleeve sleeved on the cable.

15. The assembly method of a manipulator of claim 13, wherein the second arm further comprises a cushion ring disposed around the second axle hole of the second arm before the at least one connecting member is received in the second arm; the at least one connecting member is inserted through the cushion ring when the at least one connecting member connects the second arm the coupling.

16. The assembly method of a manipulator of claim 10, wherein the first arm further comprises a cover fixed to the first main body after the driving assembly is assembled in the first main body.
